(19) United States
(12) Patent Application Publication
(10) Pub. No.: US 2008/0159071 A1
(43) Pub. Date: Jul. 3, 2008

(54) Microwave transponder

(76) Inventor: Hans Johansson, Huskvarna (SE)

Correspondence Address: SCHWEGMAN, LUNDBERG & WOESSNER, P.A., P.O. BOX 2938, MINNEAPOLIS, MN, 55402, US

(21) Appl. No.: 11/792,763

(22) PCT Filed: Dec. 16, 2005
(86) PCT No.: PCT/SE2005/001939

§ 371 Date: Jun. 8, 2007

(30) Foreign Application Priority Data
Dec. 21, 2004 (SE) 0403098-7

(51) Int. Cl. H04B 1/59

(52) U.S. Cl. 367/2

(57) ABSTRACT

The invention relates to a radio transponder (200) for reception and retransmission of electromagnetic energy, particularly in the microwave range. The transponder comprises a connection (210) to an antenna, a control circuit for modulation (260), a detector (250), a delay element (240) and a first semiconductor switch (220). The transponder comprises, in addition, a second semiconductor switch (230), and the control circuit for modulation (260) is arranged to be able to control the semiconductor switches (220, 230) independently in such a way that a signal that comes in via the antenna connection (210) can be caused to be reflected on either side of the delay element (240) or to pass through this to the detector (250). At least one of the semiconductor switches (220, 230) is suitably a diode or a transistor.

### TECHNICAL FIELD

The present invention relates to a radio transponder for reception and retransmission of electromagnetic energy, primarily in the microwave range. The transponder comprises a connector for an antenna, a control circuit for modulation, a detector and also a delay element and a first semiconductor switch.

### BACKGROUND ART

Transponders are devices that are well-known, the principal task of these being to receive and retransmit a received signal, and, if required, also to detect information in the received signal. The retransmission can be carried out with or without a modulation being added to the signal in the transponder before it is retransmitted.

In known transponders that can modulate and detect a received signal, two antennas are used, one for reception and detection and one for retransmission of the modulated signal.

The need for two antennas makes the transponder more expensive, which is, of course, a drawback.

### DISCLOSURE OF THE INVENTION

In accordance with what has been described above, there is thus a need for a transponder that can receive and retransmit a signal using only one antenna, where the retransmitted signal can have been modulated in the transponder. The transponder must preferably be able to be used in the microwave range.

This need is met by the present invention, in that it describes a radio transponder for receiving and retransmitting electromagnetic energy, primarily in the microwave range. The transponder comprises a connector for an antenna, a control circuit for modulation, a detector and a delay element.

In addition, the transponder comprises a first and a second semiconductor switch. The transponder's control circuit for modulation is arranged to be able to control the semiconductor switches independently, so that a signal that comes in via the antenna connection can be caused to be reflected on either side of the delay element or to pass through this to the detector.

At least one of the semiconductor switches is suitably a diode or a transistor.

### BRIEF DESCRIPTION OF THE DRAWINGS

The invention will be described in greater detail in the following with reference to the attached drawings, in which

FIG. 1 shows a known transponder, and

FIG. 2 shows the transponder according to the invention.

### EMBODIMENTS

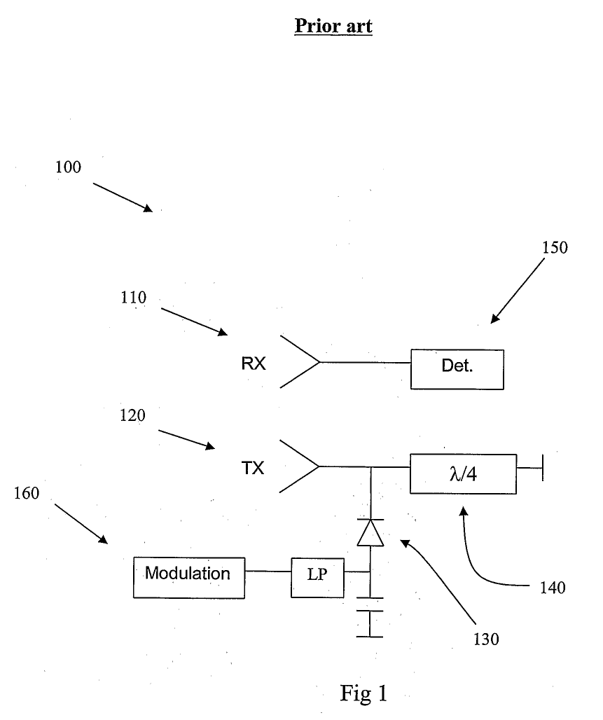

FIG. 1 shows a known transponder 100. This will be described briefly, in order to illustrate a problem with this known transponder that can be solved by the invention.

The transponder 100, can be used to receive an incoming signal, and to retransmit this signal, with or without a modulation that is added to the signal in the transponder before the signal is retransmitted.

As shown by FIG. 1, the transponder 100 comprises two separate antennas 110 and 120. One antenna 110 is a receiving antenna and is connected to a detector that is used to detect information in the received signal, and the other antenna 120 is a transmitting antenna that is used to retransmit the received signal, with or without an added modulation.

The modulation is controlled by a control circuit for modulation 160 that connects and disconnects a diode 130, in order words makes it conducting or non-conducting. Depending upon whether the diode 130 is caused to be conducting or not, the signal will either be taken through a quarter-wave transformer 140 and reflected to a short circuit, or will be reflected directly at the diode. In the event of reflection through the quarter-wave transformer, the signal will be subjected to a phase shift corresponding to 2*φ, where φ is the delay in the transformer, in the present case the total phase shift is thus 2*λ/4=λ/2.

As mentioned in the introduction, a disadvantage of the transponder 100 is that it makes it necessary to utilize two separate antennas, one for detection and one for retransmission of the signal.

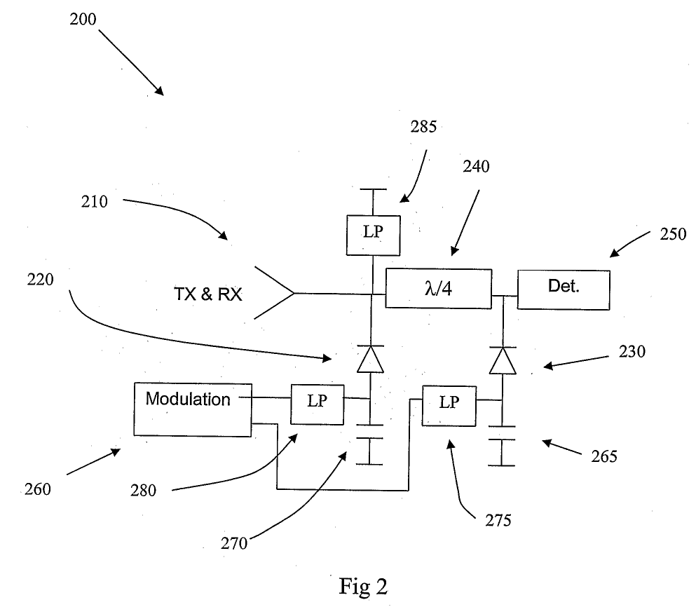

FIG. 2 shows a transponder 200 according to the invention which solves the said problem associated with the transponder 100. It can be mentioned here that; the transponder 200 is primarily intended for applications in the microwave range, but, with a suitable choice of components, the principle of the transponder 200 can also be used for other frequency ranges. By the microwave range is meant here preferably frequencies from and including 1 GHz upwards.

The transponder 200 comprises a connection 210 to an antenna. The antenna can, of course, be incorporated in the transponder, but can also be an external unit that is connected via the connection 210.

The antenna input 210 is connected in such a way that a received signal is taken to a delay element or phase shifter 240. The delay or phase shift can be selected on the basis of the application, but in the present case an element is used that gives a delay of λ/4, where λ is the central frequency in the area of application for the transponder 200.

A detector 250 is connected in series with the delay element 240, which detector can detect information that is in a received signal.

In addition, the transponder 200 comprises a first 220 and a second 230 semiconductor switch, suitably in the form of diodes, that are connected to separate sides of the delay element 240. The semiconductor switches are also connected to ground, suitably via separate capacitances 270, 265, that block the control signals to the diodes by DC means. In a preferred embodiment, the semiconductor switches consist of diodes, and in the following they will be referred to as diodes, but one or both switches can also consist of transistors. Other types of switches are also possible, for example so-called MEMS switches.

The transponder 200 also comprises a control circuit for modulation 260, which is connected to the two diodes separately, suitably via one low-pass filter 280, 275 per diode. The control circuit can cause the two diodes 220, 230 to be conducting or non-conducting. The following states can then arise:

| The diode 220 | The diode 230 | Result |
|---|---|---|
| Conducting | Non-conducting | Reflection before the |
| | | delay element. |
| Non-conducting | Conducting | Reflection after the |
| | | delay element. |
| Non-conducting | Non-conducting | Signal to the detector. |
| Conducting | Conducting | Reflection before the |
| | | delay element. |

Thus if the first diode 220 is made conducting, a received signal will be shorted to earth, in other words will be reflected in the diode.

The invention is intended to provide a transponder that can be as inexpensive as possible, which means that there will be a desire to use diodes that are as inexpensive as possible. Inexpensive diodes normally cause reflections in the diode in a conducting state, while more expensive diodes do not produce this reflection. In the latter case, the reflection will take place before the delay element, namely in the capacitance 270 via which the first diode 220 is connected to earth.

If the first diode 220 is made non-conducting and the second diode 230 is made conducting, the signal will be reflected in the same way at a point after the delay element 240, a point that is determined by the quality of the diode, but where both the possible reflection points give the intended result.

If, on the other hand, the control circuit for modulation causes both the diodes to be non-conducting, a received signal will pass through the quarter-wave transformer to the detector 250 for extraction of any information content in the signal.

The control circuit for modulation 260 is suitably connected to each of the diodes via a low-pass filter 275, 280.

As also shown in FIG. 2, the first diode 220 is connected to ground via a low-pass filter 285 that passes modulation currents. The first diode is connected to the filter 285 via the same end of the diode that is connected to the input of the quarter-wave transformer.

The invention is not restricted to the embodiments described above, but can be varied freely within the framework of the following claims.

For example, the device can comprise a delay element with, in principle, any delay, entirely dependent upon what total delay is required.

The type of modulation that utilizes the shown phase positions, 0 and 180 degrees, is so-called BPSK. A device according to the invention can also be used for types of modulation that utilize several phase positions, for example so-called QPSK that utilizes four phase positions. In this case, one delay element is required per phase position, plus a diode on each side of each delay element, in a similar way to as shown in FIG. 2.

The diodes are utilized by the control device to determine whether the signal is to pass through one, two, three or all four delay elements before it is reflected, whereby the required phase position is obtained. It is recognized that this principle can be varied in a large number of ways, with different numbers of delay elements and diodes.

1. Radio transponder for reception and retransmission of electromagnetic energy, which transponder comprises:
an antenna connection,
a control circuit for modulation,
a detector,
a delay element,
a first semiconductor switch,
a second semiconductor switch, and
wherein the control circuit for modulation is arranged to control the first and second semiconductor switches independently in such a way that a signal that comes in via the antenna connection can be caused to be reflected on either side of the delay element or to pass through this to the detector.

2. Radio transponder according to claim 1, in which at least one of the first and second semiconductor switches comprises a diode.

3. Radio transponder according to claim 1, in which at least one of the first and second semiconductor switches comprises a transistor.

4. Radio transponder of claim 1, further comprising at least a first low-pass filter arranged between the control circuit for modulation and one of the first and second semiconductor switches.

5. Radio transponder according to claim 1, wherein the delay element and the detector are connected in series with the connector for an antenna.

6. Radio transponder according to claim 1, wherein the delay element provides a delay of a quarter of a wavelength.

7. Method for receiving radio signals primarily in the microwave range in a radio transponder, comprising:
utilizing a connection to a single antenna, and
controlling a control circuit to bring about one of the following three options for a received signal:
direct retransmission,
modulated retransmission,
detection in a detector.

8. Method according to claim 7, according to which the control circuit utilizes a first and a second semiconductor switch.

9. Method according to claim 7, according to which the modulation is carried out by means of a delay element through which the signal can be taken by means of one semiconductor switch.

10. Method according to claim 7, wherein the delay that is obtained by means of the delay element is a quarter of a wavelength.

11. A method for receiving microwave electromagnetic signals, comprising:
receiving a signal at a connection to a single antenna; and
controlling the path of the signal to either pass through a delay element or bypass the delay element through a first controllable switch and a second controllable switch, wherein controlling includes enabling one of direct retransmission, modulated retransmission, and detection in a detector.

12. The method of claim 11, wherein controlling the path includes placing both controllable switches in a non-conducting mode such that the signal travels through the delay element and detecting the signal in a detector at a non-antenna side of the delay element.

13. The method of claim 12, wherein controlling includes delaying the signal by of a quarter of a wavelength.

14. The method of claim 11, wherein controlling the path includes placing the first controllable switch in a conducting mode and placing the second switch in a non-conducting mode to reflect the signal before the delay element.

15. The method of claim 11, wherein controlling the path includes placing the first controllable switch in a non-conducting mode and placing the second switch in a conducting mode to reflect the signal after the delay element.

16. The method of claim 11, wherein controlling the path includes placing the first controllable switch in a conducting mode and placing the second switch in a conducting mode to reflect the signal before the delay element.
